(19) United States
(12) Patent Application Publication
(10) Pub. No.: US 2015/0213563 A1
(43) Pub. Date: Jul. 30, 2015

(54) Methods and Systems of Production System Management

(71) Applicant: Ag Property Solutions, LLC, Emmetsburg, IA (US)

(72) Inventors: Pat Joyce, Emmetsburg, IA (US); Derrick Sleezer, Cherokee, IA (US); Jason Plunkett, Berthoud, CO (US)

(21) Appl. No.: 14/606,576

(22) Filed: Jan. 27, 2015

Related U.S. Application Data
(60) Provisional application No. 61/931,989, filed on Jan. 27, 2014.
(60) Provisional application No. 62/004,660, filed on May 29, 2014.

(51) Int. Cl. G06Q 50/02; G06Q 10/06; G06Q 30/00

(52) U.S. Cl. CPC G06Q 50/02; G06Q 30/018; G06Q 10/06398

(57) ABSTRACT

The various embodiments disclosed herein relate to network-based systems for managing various operational parameters associated with one or more sites of a production operation, including in certain implementations a livestock production operation.

### CROSS-REFERENCE TO RELATED APPLICATION(S)

This application claims the benefit under 35 U.S.C. §119(e) to U.S. Provisional Application 61/931,989, filed Jan. 27, 2014 and entitled “Methods and Systems of Production System Management,” and further to U.S. Provisional Application 62/004,660, filed May 29, 2014 and entitled “Methods and Systems of Production System Management,” both of which are hereby incorporated herein by reference in their entireties.

### FIELD OF THE INVENTION

The field of the various embodiments disclosed herein relates generally to network-based systems for managing various operational parameters associated with one or more sites of a production system, and more specifically in certain implementations to such systems for managing a livestock production operation. Various specific embodiments include such systems for tracking implementation of a policy or protocol, tracking employee proficiency, tracking compliance and audits, and/or tracking service and maintenance.

### BACKGROUND OF THE INVENTION

There are many challenges in livestock production systems related to managing the operational activities of personnel that are mobile and/or working in very remote locations. Further, there are increasing demands for compliance audits in livestock agriculture relating to process quality assurance as driven by stakeholders, the general public, and/or regulation.

Mature systems currently exist to manage accounting, payroll and human resource, and inventory and production activities. However, management of certain other operational activities and processes is typically addressed through external, manual or fragmented systems.

There is a need in the art for improved methods and systems for tracking and/or managing various operational parameters associated with one or more sites of a production system, such as a livestock production system.

### BRIEF SUMMARY OF THE INVENTION

Discussed herein are various network-based systems for tracking and managing various operational parameters of a production operation, such as a livestock production operation.

In Example 1, a network-based system for tracking and managing various operational parameters of a production operation comprises a central processor accessible on a computer network, a database in communication with the central processor, and standard compliance tracking software associated with the central processor, the standard compliance tracking software configured to track compliance with a standard associated with the at least one asset or site. The database is configured to store site and asset information relating to at least one site and at least one asset and compliance standard and audit information relating to the at least one site and the at least one asset.

Example 2 relates to the system according to Example 1, wherein the standard compliance tracking software is further configured to calculate compliance with the standard based on a score.

Example 3 relates to the system according to Example 2, wherein the standard compliance tracking software is further configured to use a scoring matrix to calculate compliance with the standard. Example 4 relates to the system according to Example 1, wherein the standard compliance tracking software is further configured to generate a completed audit report.

Example 5 relates to the system according to Example 1, wherein the standard compliance tracking software is further configured to generate a standard results report.

In Example 6, a network-based system for tracking and managing various operational parameters of a production operation comprises a central processor accessible on a computer network, a database in communication with the central processor, policy and protocol tracking software, and standard compliance tracking software. The database is configured to store site and asset information relating to at least one site and at least one asset, policy and protocol information relating to the at least one site and the at least one asset; and compliance standard and audit information relating to the at least one site and the at least one asset. The policy and protocol tracking software is associated with the central processor and configured to track implementation of a policy or protocol associated with at least one asset or site. The standard compliance tracking software is associated with the central processor and configured to track compliance with a standard associated with the at least one asset or site.

Example 7 relates to the system according to Example 6, wherein the standard compliance tracking software is further configured to calculate compliance with the standard based on a score.

Example 8 relates to the system according to Example 7, wherein the standard compliance tracking software is further configured to use a scoring matrix to calculate compliance with the standard.

Example 9 relates to the system according to Example 6, wherein the standard compliance tracking software is further configured to generate a completed audit report.

Example 10 relates to the system according to Example 6, wherein the standard compliance tracking software is further configured to generate a standard results report.

Example 11 relates to the system according to Example 6, further comprising the database being further configured to store employee and user information, and testing and training information relating to at least one employee, and employee proficiency tracking software associated with the central processor, the employee proficiency tracking software configured to track test results associated with the at least one employee.

Example 12 relates to the system according to Example 6, further comprising the database being further configured to store compliance standard and audit information relating to the at least one site and the at least one asset, and compliance and audit tracking software associated with the central processor, the compliance and audit tracking software configured to track audit results associated with the at least one asset or site.

Example 13 relates to the system according to Example 6, further comprising the database being further configured to store service provider information relating to the at least one site and the at least one asset, and service and maintenance tracking software associated with the central processor, the service and maintenance tracking software configured to identify an appropriate service provider based on a service request.

Example 14 relates to the system according to Example 13, wherein the service and maintenance tracking software is further configured to transmit a service request to the appropriate service provider.

In Example 15, a network-based system for tracking and managing various operational parameters of a production operation comprises a central processor accessible on a computer network, a database in communication with the central processor, employee proficiency tracking software, policy and protocol tracking software, standard compliance tracking software, and service and maintenance tracking software. The database is configured to store site and asset information relating to at least one site and at least one asset, employee and user information, policy and protocol information relating to the at least one site and the at least one asset, testing and training information relating to at least one employee, compliance standard and audit information relating to the at least one site and the at least one asset, and service provider information relating to the at least one site and the at least one asset. The employee proficiency tracking software is associated with the central processor and is configured to track test results associated with the at least one employee. The policy and protocol tracking software is associated with the central processor and is configured to track implementation of a policy or protocol associated with at least one asset or site. The standard compliance tracking software is associated with the central processor and is configured to track compliance with a standard associated with the at least one asset or site. The service and maintenance tracking software is associated with the central processor and is configured to identify an appropriate service provider based on a service request.

Example 16 relates to the system according to Example 15, wherein the standard compliance tracking software is further configured to calculate compliance with the standard based on a score.

Example 17 relates to the system according to Example 16, wherein the standard compliance tracking software is further configured to use a scoring matrix to calculate compliance with the standard.

Example 18 relates to the system according to Example 15, wherein the standard compliance tracking software is further configured to generate a completed audit report.

Example 19 relates to the system according to Example 15, wherein the standard compliance tracking software is further configured to generate a standard results report.

While multiple embodiments are disclosed, still other embodiments of the present invention will become apparent to those skilled in the art from the following detailed description, which shows and describes illustrative embodiments of the invention. As will be realized, the invention is capable of modifications in various obvious aspects, all without departing from the spirit and scope of the present invention. Accordingly, the drawings and detailed description are to be regarded as illustrative in nature and not restrictive.

### BRIEF DESCRIPTION OF THE DRAWINGS

FIG. 1 is a flow chart depicting the operation of a system for tracking and/or managing any combination of various operational parameters associated with one or more sites of a production system, according to one embodiment.

FIG. 2 is a block diagram of a network-based system for calculating, tracking, and/or managing various operational parameters associated with one or more sites of a production system, according to one embodiment.

FIG. 3 is a flow chart illustrating a method of implementing, tracking, and/or managing policies and/or protocols of one or more assets or one or more sites, according to one embodiment.

FIG. 4A depicts a sample user interface relating to the tracking or management of policies or protocols, according to one embodiment.

FIG. 4B depicts another aspect of the sample user interface of FIG. 4A.

FIG. 5 is a flow chart illustrating a method of testing, tracking, and managing the proficiencies or skill sets of one or more employees or one or more sites, according to one embodiment.

FIG. 6A depicts a sample user interface relating to the tracking or management of employee proficiencies, according to one embodiment.

FIG. 6B depicts another aspect of the sample user interface of FIG. 6A.

FIG. 7 is a flow chart illustrating a method of tracking compliance of various requirements, rules or laws relating to one or more assets or one or more sites via audits, according to one embodiment.

FIG. 8A depicts a sample user interface relating to the tracking or management of compliance audits, according to one embodiment.

FIG. 8B depicts another aspect of the sample user interface of FIG. 8A.

FIG. 8C depicts another aspect of the sample user interface of FIG. 8A.

FIG. 8D depicts another aspect of the sample user interface of FIG. 8A.

FIG. 8E depicts another aspect of the sample user interface of FIG. 8A.

FIG. 8F depicts another aspect of the sample user interface of FIG. 8A.

FIG. 8G depicts another aspect of the sample user interface of FIG. 8A.

FIG. 9 is a flow chart illustrating a method of servicing and maintenance of assets by service providers, including third party providers or in-house personnel, according to one embodiment.

FIG. 10A depicts a sample user interface relating to the tracking or management of work orders, according to one embodiment.

FIG. 10B depicts another aspect of the sample user interface of FIG. 10A.

FIG. 10C depicts another aspect of the sample user interface of FIG. 10A.

FIG. 10D depicts another aspect of the sample user interface of FIG. 10A.

FIG. 11 depicts one example of a report relating to audit scoring and reporting, according to one embodiment.

### DETAILED DESCRIPTION

Various embodiments of methods and systems described herein relate to tracking and/or managing any combination of various operational parameters (including operational activities and processes) associated with one or more sites (and/or assets) of a production system, such as a livestock production system. The various operational parameters can include, for example, policy and protocol management, employee proficiency and training management, regulatory compliance management, and work order management. It is understood that the various implementations disclosed and contemplated herein can be used to track and/or manage various operational parameters in production systems in many different industries and business sectors beyond agriculture.

As described in further detail below, the tracking and/or managing of operational parameters of a production system primarily focus on centralizing and integrating management requirements for operational activities relating to the interaction of personnel with assets, vendors and process. The various system and method embodiments constitute continuous improvement strategies for continuously improving the management and tracking of the various operational parameters. The systems/methods are intended to allow for administration with visibility and management with accountability of the various parameters, including, for example, process and quality assurance standards as defined by an organization, stakeholders and/or regulators. Further, they are intended to close communication gaps between management, remote locations, personnel and vendors using a network-based system accessible via one or more interfaces (such as computers or smartphones) having intuitive navigation structures, thereby reducing or eliminating the need for fragmented communication through paper forms, emails and voicemails.

In use as will be described in further detail below, the various system and method embodiments disclosed herein can track and manage work orders (such as work orders to repair equipment, for example), track and manage policies and protocols, track and manage employee proficiency testing and training, track and manage audits relating to compliance, and generate easily modifiable reports and/or instructions relating to any of these operational activities and processes.

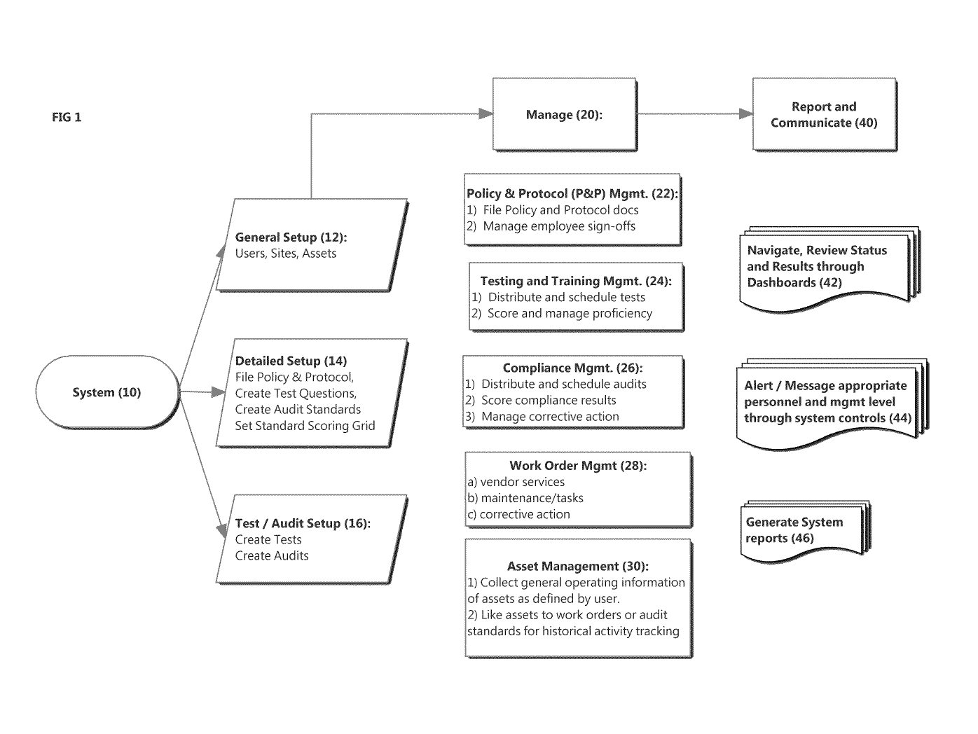

FIG. 1 is a flow chart depicting the overall operation of a method and system for tracking and/or managing any combination of various operational parameters (including operational activities and processes) 10 associated with one or more sites of a production system, such as a livestock production system, according to one embodiment. The system 10 generally comprises managing and tracking policies and protocols relating to production at at least one site (block 22), managing, testing, assessing, and tracking employee proficiencies at the at least one site (block 24), managing and tracking compliance with any rules and/or regulations at the at least one site (block 26), managing and tracking service and maintenance (referred to as “work orders” in some instances) relating to at least one piece of equipment at the at least one site (block 28), and managing and tracking assets at the at least one site (block 30).

Continuing with FIG. 1, in one aspect, the system 10 can also allow a user to generate reports of various kinds relating to the various functions described above (block 46). In an alternative embodiment, the system 10 can also provide for generating instructions to appropriate individuals based on the various functions described above (block 44).

The various operational parameters as shown in FIG. 1 (including managing and tracking policies and protocols; managing, testing, assessing, and tracking employee proficiencies; managing and tracking compliance; managing and tracking service and maintenance; and managing and tracking assets) of the various embodiments described herein can be used in a variety of different ways to track and/or manage the operation of one or more employees, one or more pieces of equipment, one or more sites, or an entire enterprise, as will be explained in further detail below.

It is understood that the equipment or sites tracked by the various systems and methods described herein can be any type of equipment or sites utilized by any entity with an interest in such tracking, calculation, and or management as described herein. In one embodiment, the equipment and multiple sites are those of a production entity that utilizes one of the systems or methods described herein to track or manage the various operational parameters at each site and overall. One specific, non-limiting example is a livestock production entity.

System Components

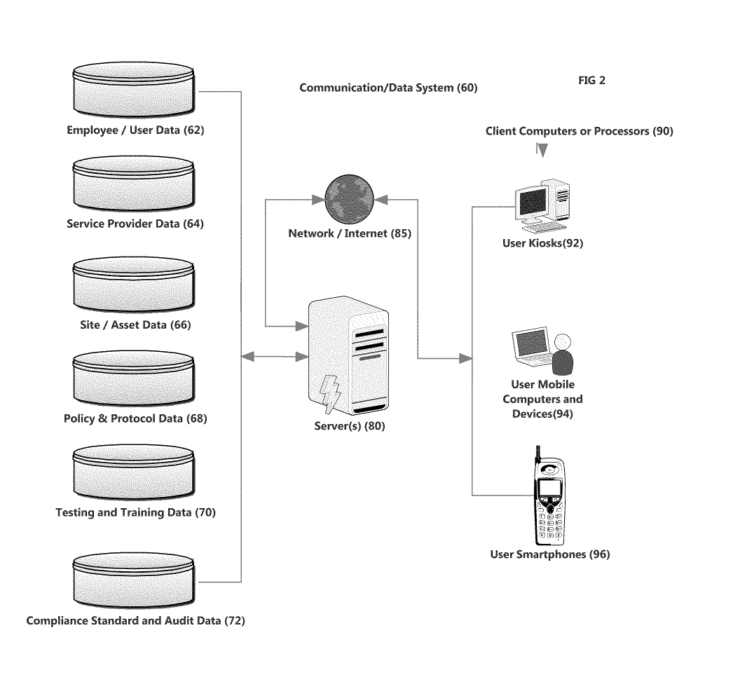

FIG. 2 depicts a schematic diagram of one embodiment of a network-based system for calculating, tracking, and/or managing such parameters as described above for one or more pieces of equipment, one or more sites, one or more regions, or an entire enterprise. The system 60 according to one embodiment can include a server 80 in communication with client computers or processors 90, which can include user mobile computers and devices 94 (such as client smartphones 96) and/or kiosks 92, through a network 85. The client computers 90 can be located at one or more of the various distributed sites of a distributed enterprise, mobile, or could be located at other locations, such as third party sites. “Client computers” as used herein shall mean any known type of processor, computer or handheld device (including a smartphone 96, for example), and can also be referred to as site processors 90 or site computers. The system 60 allows a distributed enterprise to track and/or manage assets and various operating parameters as described herein at one or more of multiple sites.

As further shown in FIG. 2, according to one implementation, the server 80 is in communication with at least one of an site/asset database 66, a service provider database 64, a testing and training database 70, a policy and protocol database 68, a compliance database 72, and/or an user/employee database 62. According to one embodiment, the site/asset database 66 contains information regarding each piece of equipment, such as equipment identification, description, base cost, historical maintenance and service information, or any other kind of information relating to a piece of equipment. The service provider database 64 contains various information regarding service providers. Further, the testing and training database 70 contains test questions and accumulation of individual questions referred to as “tests”. The policy and protocol database 68 contains information relating to any policies or protocols implemented with respect to any site or the entire enterprise or any other kind of information relating to policies or protocols. The compliance database 72 contains information relating to any regulatory compliance requirements or any other type of compliance requirements, scoring matrix for compliance metric reporting, or any other kind of information relating to compliance. The employee database 62 contains information relating to each employee, including proficiency information, or any other kind of information relating to an employee.

Alternatively, the asset or equipment data, service data, site data, policy and protocol data, compliance data, and employee data are maintained in a single database.

It is understood that the server or central processor 80 (also referred to herein as an “enterprise processor”) can be any computer known to those skilled in the art. In one embodiment, the central processor 80 includes a website hosted in at least one or more computer servers. It is understood that any system disclosed herein may have one or more such server 80 and that each server may comprise a web server, a database server and/or application server, any of which may run on a variety of platforms.

According to one embodiment, the enterprise processor or processors 80 comprise a central processor unit (“CPU”) and main memory, an input/output interface for communicating with various databases, files, programs, and networks (such as the Internet), and one or more storage devices. The storage devices may be disk drive devices or CD-ROM devices. The enterprise processor 80 may also have a monitor or other screen device and an input device, such as a keyboard, a mouse, or a touch sensitive screen. Some non-limiting commercial examples of servers that could be used with various embodiments disclosed herein include Dell 2950, Sun Solaris, HP 9000 series, and IBM x3000 series.

In one implementation, the central processor 80 includes software programs or instructions that run on the server-side to process requests and responses from a client computer 54. These software programs or instructions send information to the client computer 90, perform calculation, compilation, and storage functions, transmit instructions to the client computer 90, and generate reports. It is understood that any embodiment of the systems disclosed herein that provide for data collection, storage, tracking, and managing can be controlled using software associated with the system. It is further understood that the software utilized in the various embodiments described herein may be a software application or applications that are commercially sold and normally used by those skilled in the art or it may be a specific application or applications coded in a standard programming language.

It is further understood that the software can be any known software for use with the systems described herein to track, calculate, and manage the various parameters as described herein. For example, as described in further detail herein, various embodiments of the systems described herein could have any one or more of software for tracking assets, work orders, sites, policies and protocols, compliance, and employee proficiencies of one or more sites or the entire enterprise, or software allowing for optimization of any one of these parameters.

The central processor 80 allows access by the client processor 80 to various network resources. In one embodiment, the central processor 80 also has access, via the network 85 or some other communication link, to external data sources that may be used to keep the information in the server current. In one implementation, a number of site computers 90 may be connected to the server at any given time, and therefore a number of an enterprise's facilities or locations may utilize the system simultaneously.

In the system 60, generally, equipment data (such as, for example, cost data, repair data, maintenance data, etc.) entered into the system 60 via a client computer or processor 90 is received by the server 80 and stored in the asset database 66. Alternatively, it can be stored in any of the appropriate databases of the system.

The databases 62, 62, 64 66, 68, 70, 72 serve as the inputs to and information storage for the management and tracking system 60, which processes the information as described below and generates any one or more of notifications, reports, work orders, suggested actions, and/or instructions to a user or to a piece of equipment or a third party system.

According to one embodiment, the databases 62, 62, 64 66, 68, 70, 72 may be of any type generally known in the art. The databases 62, 62, 64 66, 68, 70, 72 may be integral to the central processor 80 or they may be accessible to the central processor 80 through a computer network or other suitable communication link. In one embodiment, the databases 62, 62, 64 66, 68, 70, 72 are comprised of a plurality of database servers, some of which are integral to the central processor 80, and some that are located remotely from the central processor 80. Some non-limiting commercial examples of databases that could be used with various embodiments disclosed herein include Oracle 9i, Oracle 10g, Microsoft SQL Server, PostSQL, and Ingress.

The site, asset or equipment database includes general site and asset information relating to each asset in the system and service information for each asset. As used herein, “asset” is intended to include any item or piece of equipment that an enterprise might have an interest in tracking or managing. The asset information may include site information relating to all sites where the client has assets, including specific areas within the site, specific locations within the area, and specific identification of assets at the site, and other relevant site information. Alternatively, the site information can be stored or maintained in the site database 66. The asset information may also include manufacturer information, supplier information, warranty information, and any other relevant information for each asset. If the asset is one part of a system comprised of more than one asset, the asset information may include system information, including the system name, description of the system, identification of the assets in the system, system status, along with any other relevant information. The system status options may include, for example and without limitation, normal operation, provisional operation, under repair, or being retrofitted. Further, the database 66 can include any additional information known to be useful in asset management.

The service provider database 64 includes general service and/or maintenance provider information and certification information for each service provider available to service an asset and each maintenance provider available to provide maintenance for an asset. “Service,” as used herein, is intended to encompass any type of repair, maintenance, or any other type of service that can be performed on, applied to, or otherwise provided for any type of asset. Further, “service provider,” as used herein, is intended to mean any person or entity that provides some type of repair or maintenance or any other known type of service for any type of asset. The information may include the name of the service and/or maintenance provider, a description, an address, a phone number, a mobile phone number, a fax number, an e-mail address, a username and password to log onto the system, one or more technician names, contact information for each technician, and any other relevant information. The certification information may include a qualification type, a certificate number, an expiration date for the certificate, a status, and any other relevant information. According to one embodiment, the certification information is associated with technicians.

In one embodiment, the site database 66 includes information about each site of the enterprise. For example, the database 66 includes general site information, specific areas within the site, specific locations within defined areas and specific identification of assets within defined locations.

As mentioned above, any embodiment of the systems described above can be used to track and manage at least one of work orders, policies and protocols, employee proficiency and training, and compliance audits for a site or an entire enterprise.

Data Collection/Organization

According to various embodiments of the methods and systems disclosed herein, as an initial procedure, information about at least some assets and/or sites is collected and stored in the system. It is understood that this collection or organization of existing information is an initial step to input information into or capture such information in the various embodiments of the systems described herein.

In one embodiment, at least one asset is inventoried and an asset identifier created for each asset to give it a trackable identity. This approach can provide a uniform naming convention, such that the same asset is identified by the same name or identification number each time it is entered into the system. In another embodiment, a set of appropriate data fields is associated with each asset wherein each field has a set of acceptable attributes. In this fashion, certain information specific to certain types of assets can be collected and, according to certain embodiments, only that appropriate information can be entered into the system. Once an identifier and data fields have been created for each piece of equipment, information relating to each asset can be collected. That is, certain characteristics or information of each trackable asset may be associated with the identifier.

Further, at least one site is inventoried and a site identifier created for each site to give it a trackable identity. A set of appropriate data fields is associated with each site wherein each field has a set of acceptable attributes. In this fashion, certain information specific to certain types of sites can be collected and, according to certain embodiments, only that appropriate information can be entered into the system. Once an identifier and data fields have been created for each site, information relating to each site can be collected. That is, certain characteristics or information of each trackable site may be associated with the identifier.

Tracking or Managing Policies and Protocols

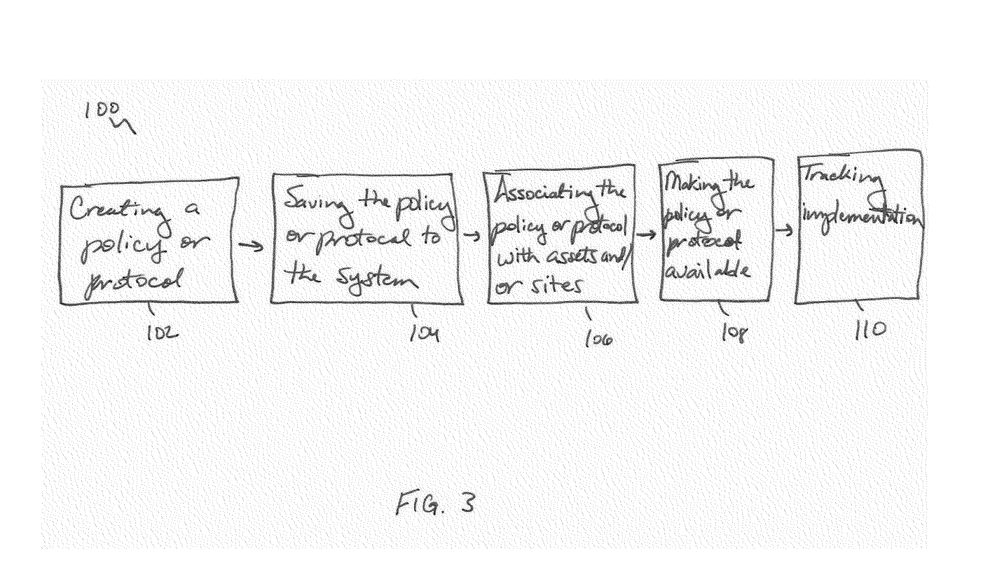

According to one embodiment, any system embodiment described herein can be used for process improvement methods such as implementing, tracking, and/or managing policies and/or protocols of one or more assets or one or more sites. As set forth in FIG. 3, the method 100 in accordance with one exemplary embodiment includes first establishing or creating a policy or protocol relating to a specific process (such as, for example, third party contracts, biosecurity requirements for trailer operation, or any other process with specific desired steps or actions) (block 102), saving the policy or protocol to the system (block 104), associating the policy or protocol with the appropriate assets and/or sites (block 106), making the policy or protocol available on an interface for appropriate users (block 108), and, in some embodiments, tracking implementation of the policy or protocol (block 110). The actual processes performed relating to these policies or protocols can be tracked over time and accessed in a real-time fashion by any user to manage the processes of interest for any specific asset, site, or the entire enterprise.

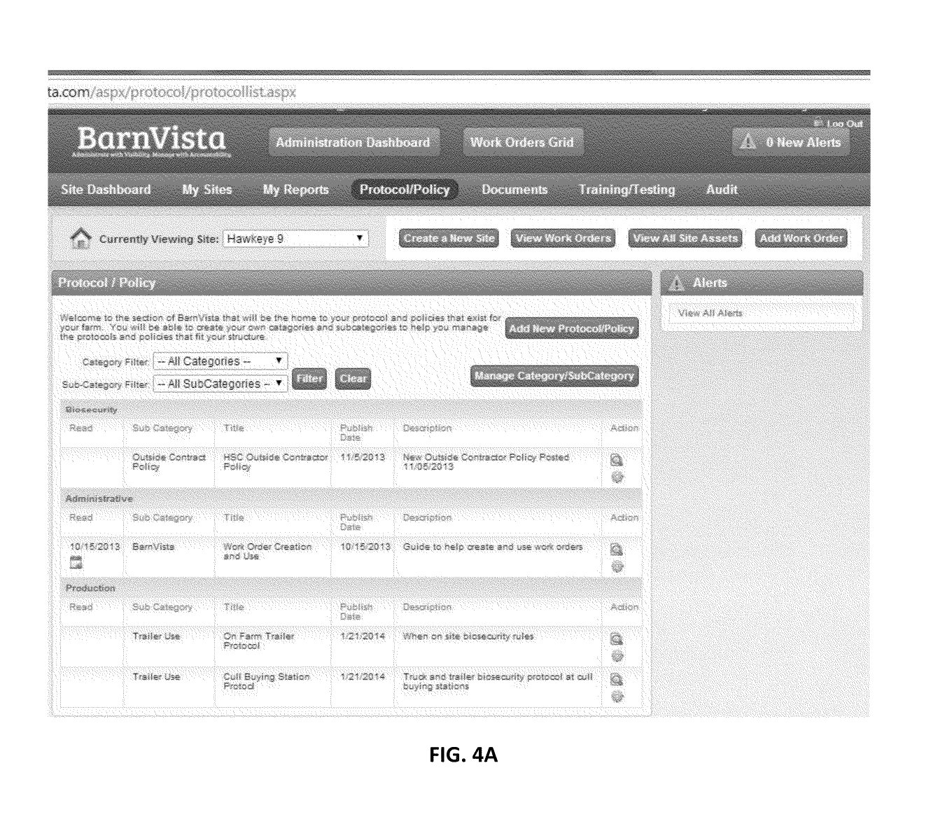

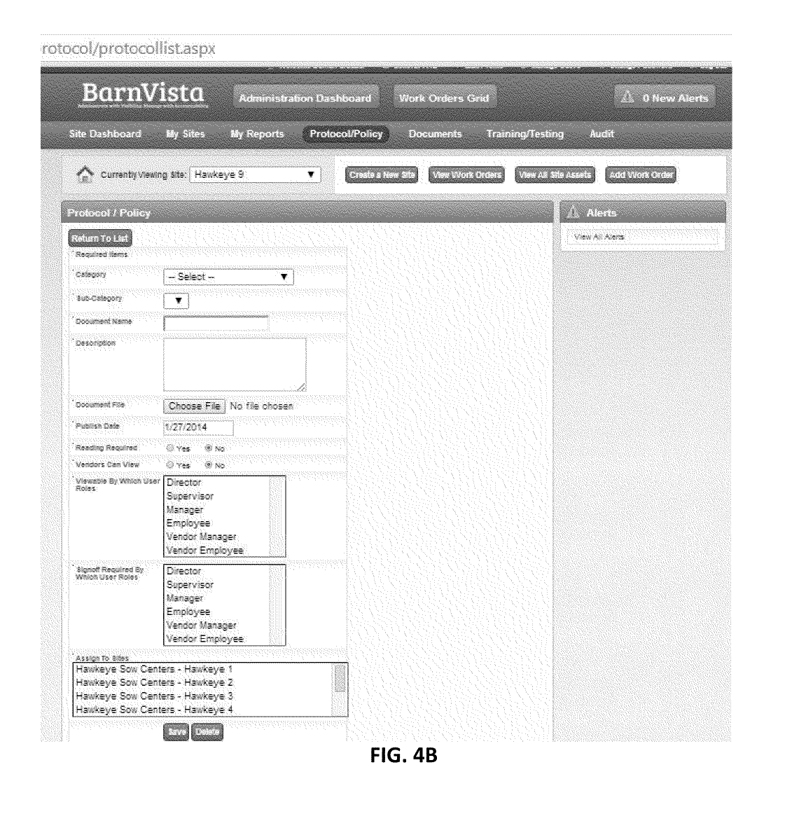

The step of making the policy or protocol available on an interface (block 108) can include making it available on an interactive webpage or other similar interface that allows a user to access a specific policy or protocol based on a specific site, a type of policy/protocol, or any other known parameter. FIGS. 4A-4B depict various aspects of an exemplary webpage of an interface relating to the tracking or management of policies or protocols. The webpage is modifiable such that a user can create her or his own categories and/or subcategories to help manage relevant protocols or policies.

For example, FIG. 4A depicts an interactive webpage that provides an index of available protocols and policies. As shown in the figure, there are category and sub-category filters that can be used by a user to limit the number of protocols or policies by certain attributes as set forth in the filters. This webpage allows a user to access any specific protocol or policy available in the system.

Further, a user can also create or add a new protocol or policy and/or manage the categories and/or subcategories associated with a protocol/policy. As shown in FIG. 4A, the user can click on the “Add New Protocol/Policy” to create a new protocol/policy, thereby accessing the webpage depicted in FIG. 4B. On this page, the user can add all the information necessary to create a new protocol/policy and add it to the system so that it appears on the list as set forth in FIG. 4A. Further, the webpage of FIG. 4B can also be used to edit an existing protocol/policy. For example, on the webpage of FIG. 4B, the user can take several steps related to creating or editing a protocol/policy, including, but not limited to: assigning the protocol/policy to a specific category and subcategory; naming the document; adding description regarding the document; selecting a file to upload; defining the publish date of the document; setting a “reading requirement;” setting the document as “viewable” and/or “sign-off required;” assigning the document to specific sites; setting the requirement for the user to enter the last four digits of the user's social security number as part of the user's sign-off validation; and/or setting the requirement for the trainer's initials as part of the user's sign-off validation. If the “reading requirement” is selected, certain users at certain sites will be required to read and acknowledge the policy/protocol.

Testing, Tracking, and Managing Employee Proficiencies

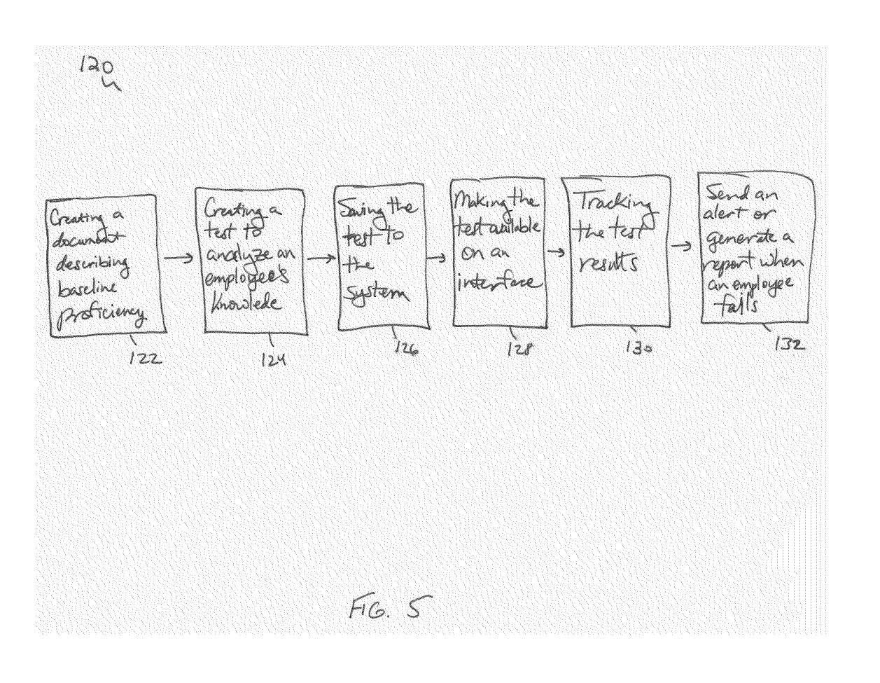

According to one embodiment, any system embodiment described herein can be used test, track, and manage the proficiencies or skill sets of one or more employees or one or more sites. As set forth in FIG. 5, the method 120 in accordance with one exemplary embodiment includes creating a document describing a baseline proficiency with respect to a specific topic or activity (block 122), creating a test to analyze an employee's knowledge of the specific topic or activity (block 124), saving the test to the system (block 126), making the test available on an interface for appropriate users (block 128), and tracking the test results of employees taking the test (block 130). In an alternative embodiment, the system can also allow for an alert to be sent to an appropriate person or a report be generated when an employee fails the test (block 132). The actual test results can be tracked over time and accessed in a real-time fashion by any user to manage the proficiencies of any employee.

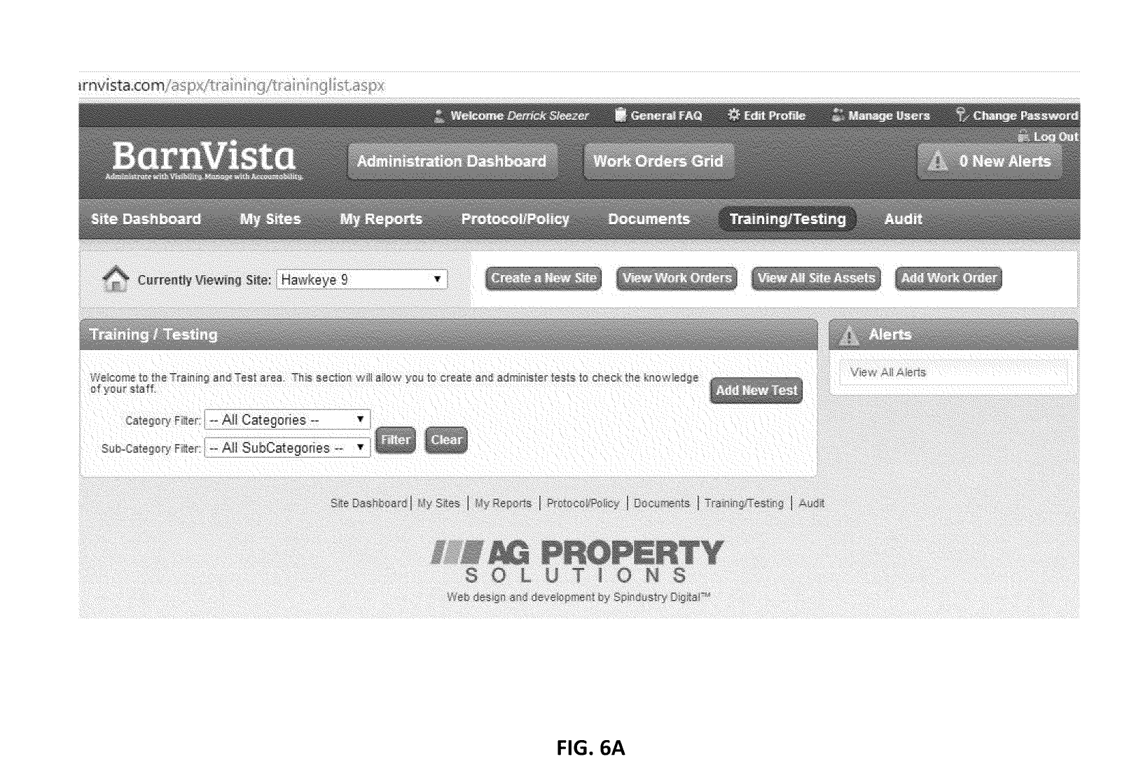

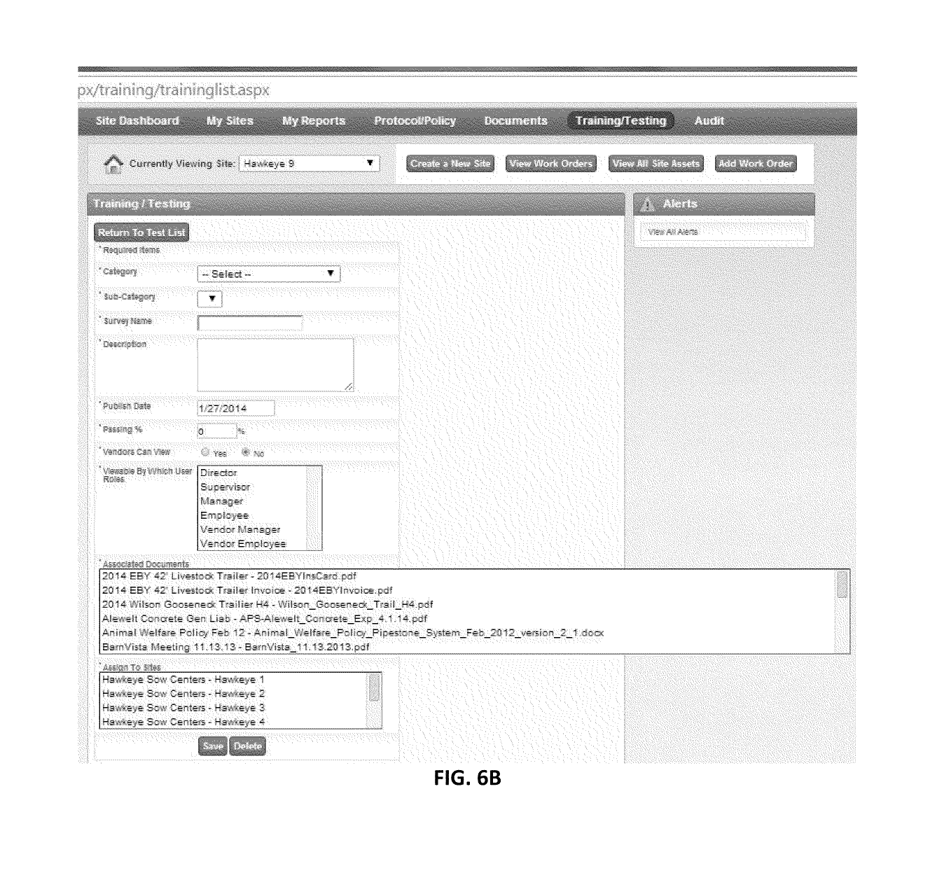

The step of making the test available on an interface (block 128) can include making it available on an interactive webpage or other similar interface that allows a user to access a specific test based on a specific site, a type of test, or any other known parameter. FIGS. 6A-6B depict various aspects of an exemplary webpage of an interface relating to the tracking or management of employee proficiencies. The webpage is configured such that a user can find any relevant test.

For example, FIG. 6A depicts an interactive webpage that provides an index of available tests. As shown in the figure, there are category and sub-category filters that can be used by a user to limit the number of tests by certain attributes as set forth in the filters. This webpage allows a user to access any specific test available in the system and review, edit, or take that test.

Further, a user can also create or add a new test and/or manage the categories and/or subcategories associated with a test. As shown in FIG. 6A, the user can click on the “Add New Test” to create a new test, thereby accessing the webpage depicted in FIG. 6B. On this page, the user can add all the information necessary to create a new test and add it to the system so that it appears on the list as set forth in FIG. 6A. Further, the webpage of FIG. 6B can also be used to edit an existing test. For example, on the webpage of FIG. 6B, the user can take several steps related to creating or editing a test, including, but not limited to: editing target dates (setting dates that this test should be completed by assigned users); editing test questions (by, for example, clicking on button to edit or establish test questions); setting categories and subcategories for indexing; naming test; describing test; publishing date; setting passing % threshold; setting whether the test is viewable by vendors; assigning positions/roles to which test is available; linking to associate documents in Document module of system for reference; and assigning test to certain sites.

Tracking or Managing Compliance and Audits

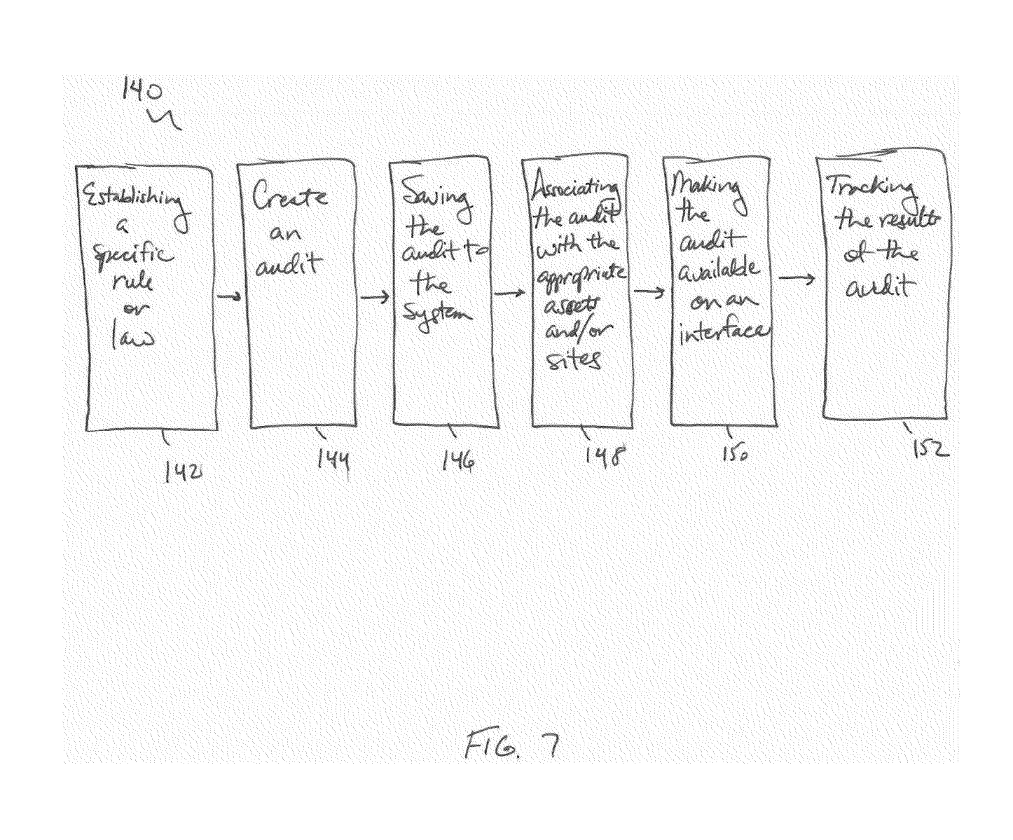

According to one embodiment, any system embodiment described herein can be used for methods of tracking compliance of various requirements, rules or laws relating to one or more assets or one or more sites via audits. As set forth in FIG. 7, the method 140 in accordance with one exemplary embodiment includes first establishing a specific rule or law (or set of rules or laws) relating to a process, an asset, or a site for which compliance is to be tracked (block 142), creating an audit to track compliance with the rule or law (or set of rules/laws) (block 144), saving the audit to the system (block 146), associating the audit with the appropriate assets and/or sites (block 148), making the audit available on an interface for appropriate users (block 150), and, in some embodiments, tracking the results of the audit (block 152). The audit results can be tracked over time and accessed in a real-time fashion by any user to manage the processes of interest for any specific asset, site, or the entire enterprise.

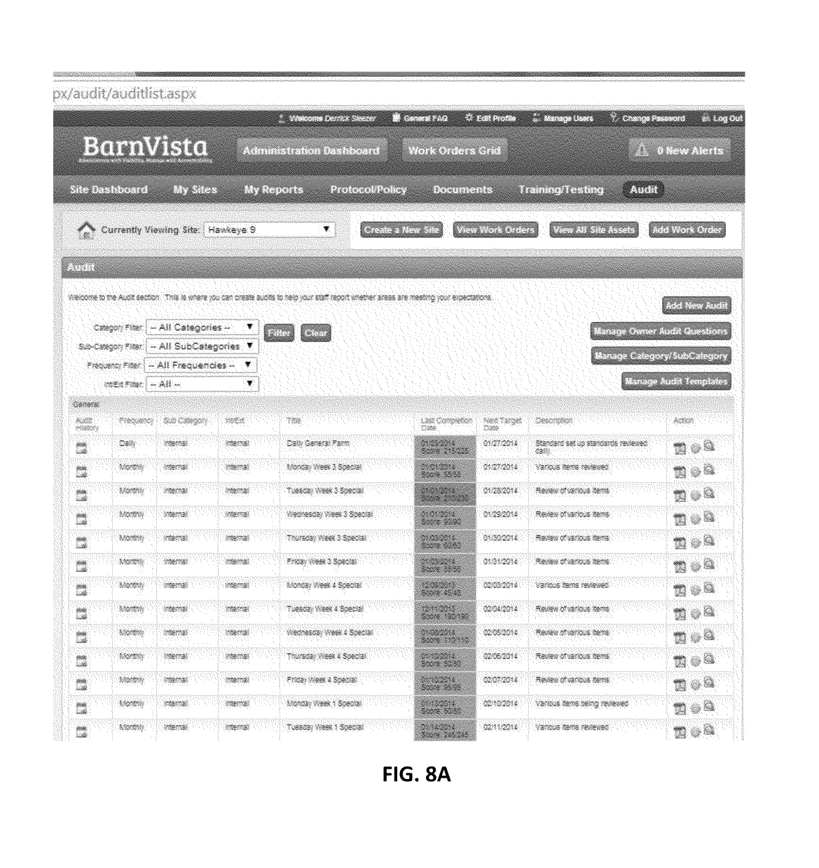

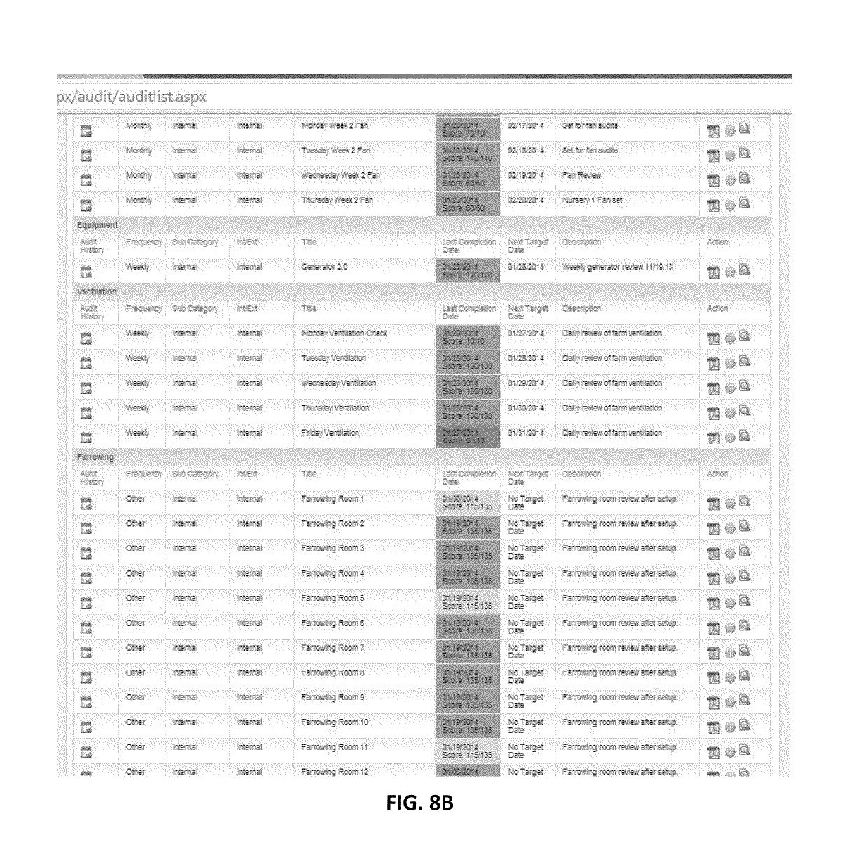

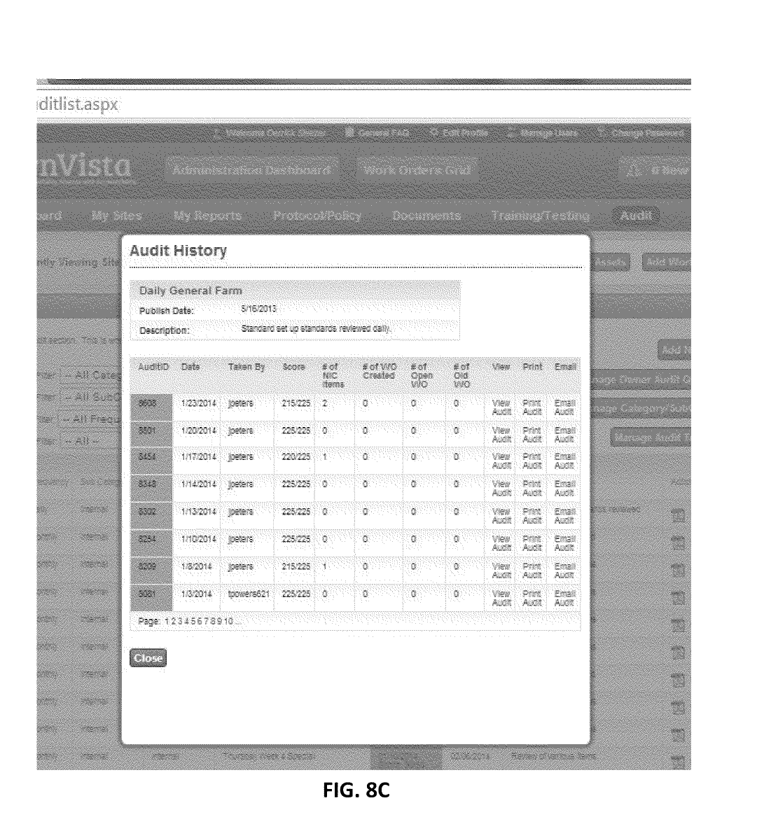

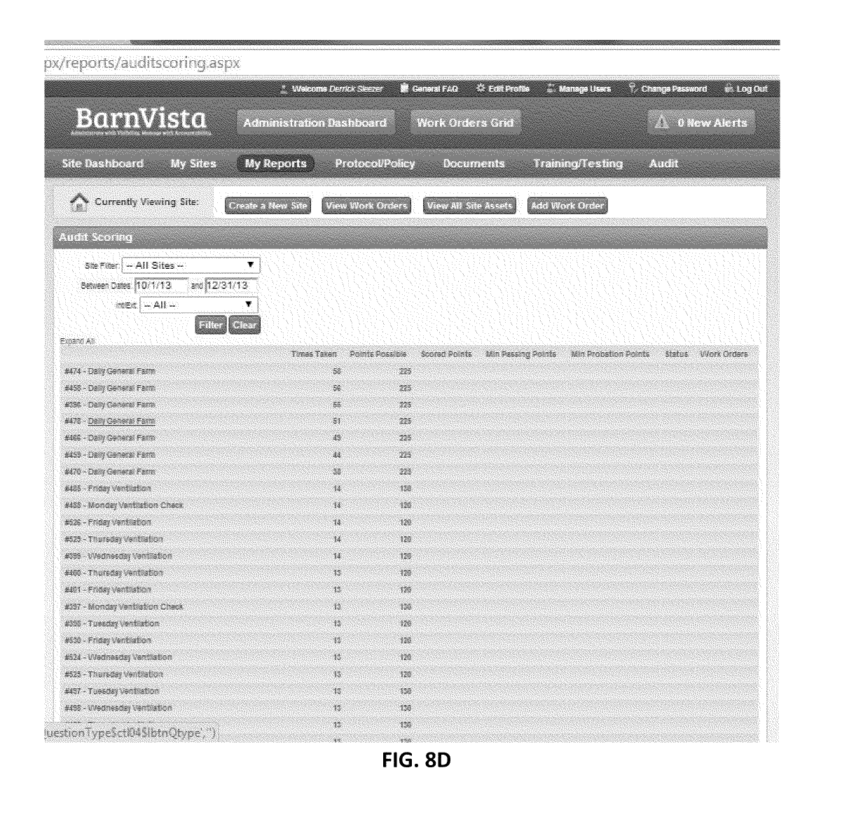

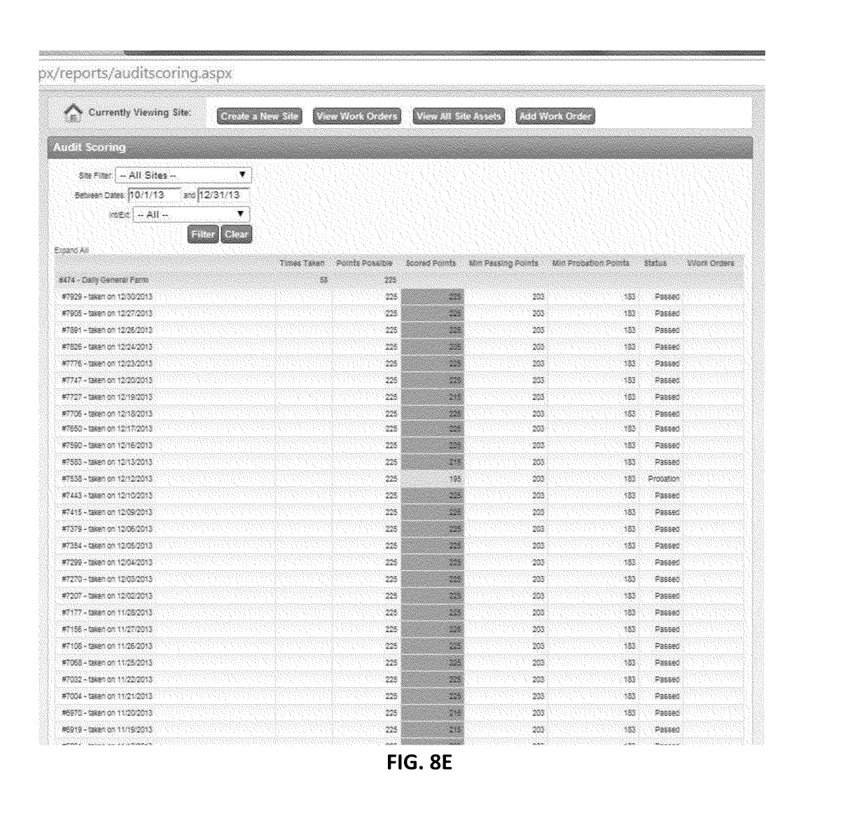

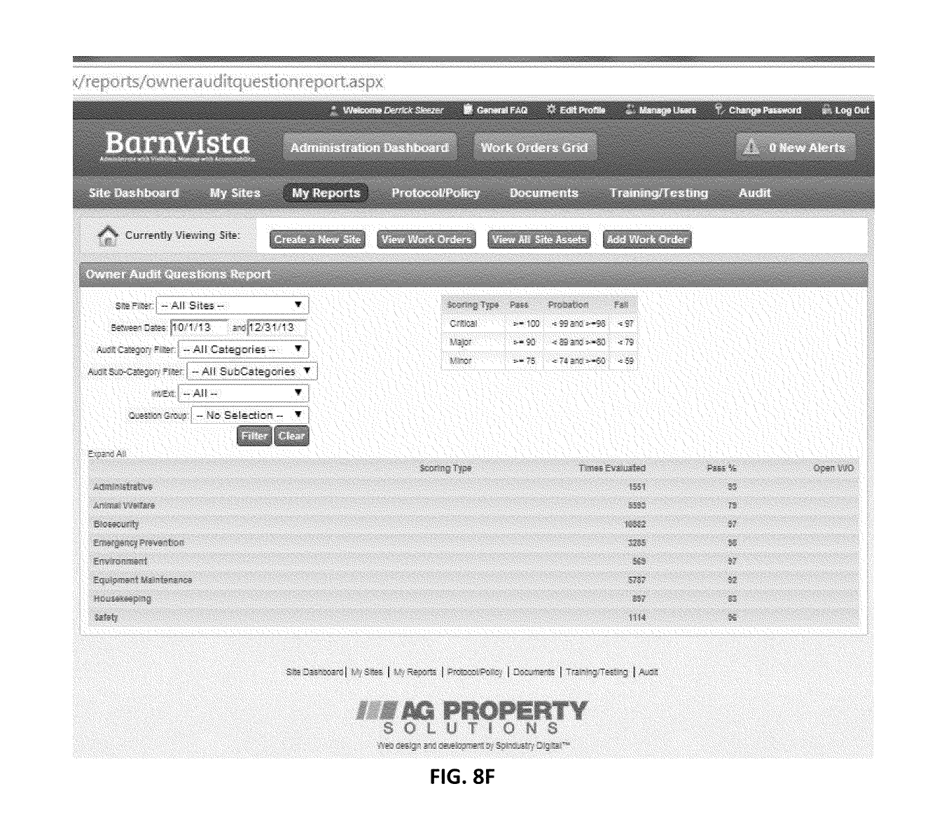

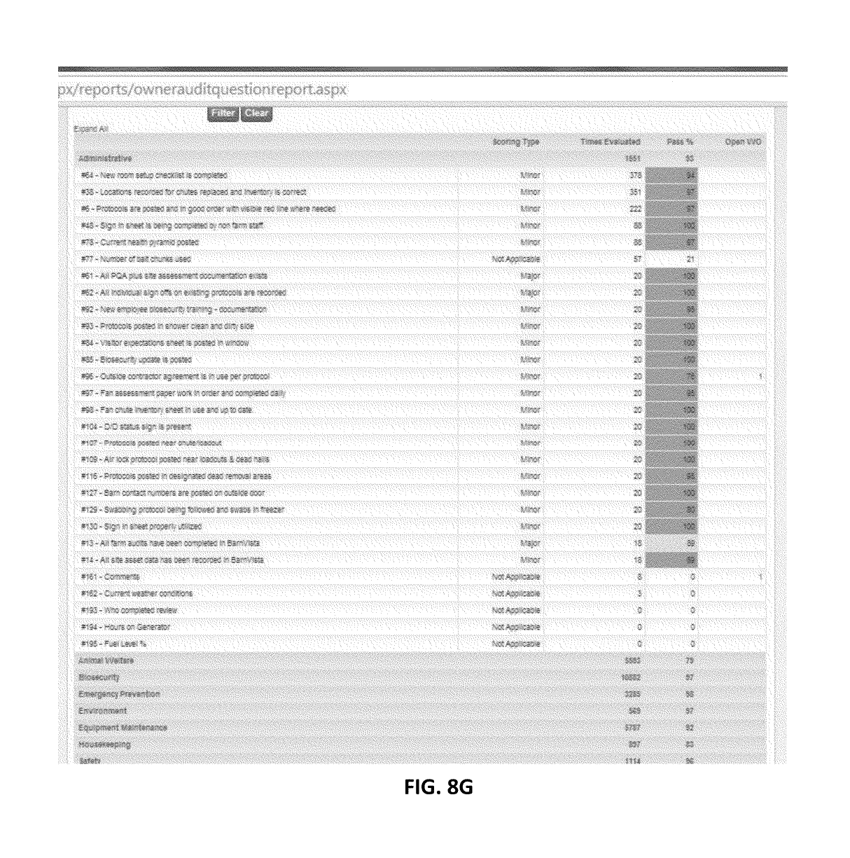

The step of making the audit available on an interface (block 150) can include making it available on an interactive webpage or other similar interface that allows a user to access a specific audit based on a specific site, a type of audit, or any other known parameter. FIGS. 8A-8G depict various aspects of an exemplary webpage of an interface relating to the tracking or management of compliance audits. The webpage is modifiable such that a user can create her or his own categories and/or subcategories to help manage relevant audits, and has filters that allow a user to easily access specific audits based on various parameters.

For example, FIGS. 8A and 8B depict an interactive webpage that provides an index of available audits. The index includes general audit info/attributes including date of last completion as well as score and scoring color code (i.e. green=passing, yellow=probation, red=failed) as determined based upon the audit scoring structure assigned. As shown in the figure, there are certain filters that can be used by a user to limit the number of audits by certain attributes as set forth in the filters, including category, sub-category, frequency (i.e. daily, weekly, monthly, etc.), and auditor (i.e. internal, external, internal/external auditor) filters. This webpage allows a user to access any specific audit available in the system and review that audit.

Further, a user can also create or add a new audit and/or manage the categories and/or subcategories associated with an audit. As shown in FIG. 8A, the user can click on the “Add New Audit” to create a new audit, click on “Manage Owner Audit Questions” to manage the database of audit standards, click on “Manage Category/Subcategory” to manage those filters, or click on “Manage Audit Templates” to manage the various templates available. Further, a user can also perform certain actions in relation to any of the individual audits. For example, the user can click on the calendar icon in the left column of any specific audit to access audit history (taking the user to a webpage similar to that shown in FIG. 8C and discussed below), click on the pdf icon in the right column of the specific audit to print a pdf of the audit template, click on the gear icon in the right column of the specific audit to edit the audit settings, or click on the magnifying glass icon in the right column to complete the audit.

By clicking on the calendar icon of any specific audit as discussed above, the user can access history of that audit at a page similar to that shown in FIG. 8C. For example, the webpage can provide certain information about the specific audit, including the date, auditor, score, the number of items not in compliance (“NIC”), the number of work orders (“WO”) created to correct the NIC items, and the number of open WOs. In addition, the user can view, print, or e-mail each such audit from that page.

Various levels of reporting are also provided by the system embodiments disclosed herein. For example, as shown in FIG. 8D, the user can access this Audit Scoring webpage that provides audit scoring reporting based on various filters, including site, date range, and auditor filters. FIG. 8E depicts expanded detail of the information provided in FIG. 8D. That is, FIG. 8E shows specific individual audits of each audit template.

In addition, at a webpage like that shown in FIG. 8F, the user can also obtain reports of standards as categories (as opposed to a composite audit score) as filtered by site, date, categories, subcategories, auditor, or any custom standard grouping. FIG. 8G depicts expanded detail of the information provided in FIG. 8F. That is, FIG. 8G provides information about performance of specific standards based on filter.

Tracking or Managing Asset Service/Maintenance

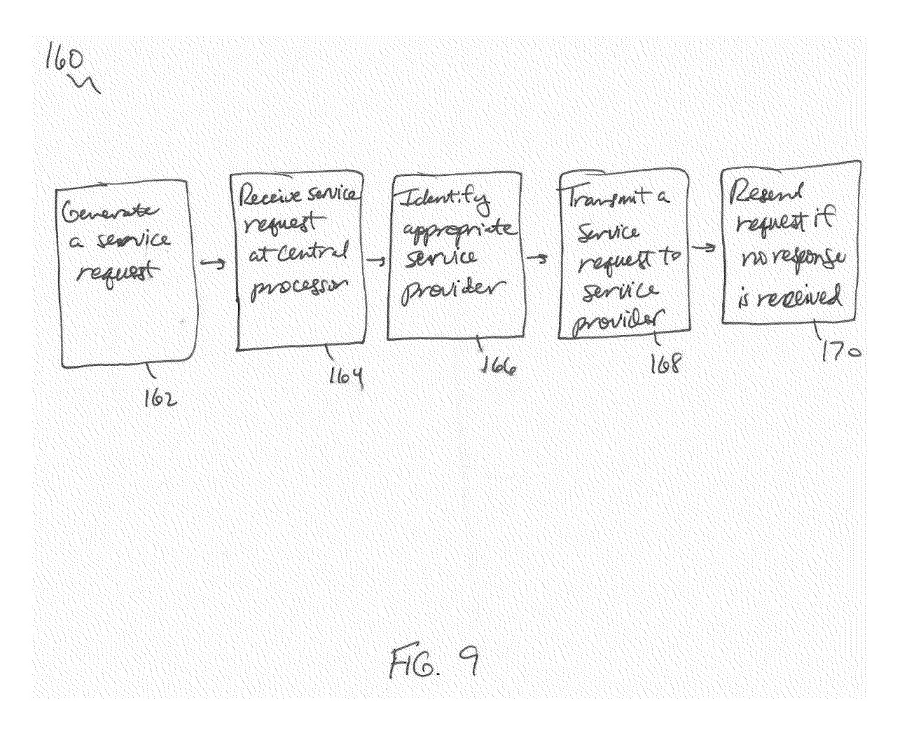

It is understood that various embodiments of the systems and methods disclose herein also provide for tracking and managing any asset service or maintenance needs. One exemplary embodiment of the system provides for a method of servicing and maintenance of assets by service providers, including third party providers or in-house personnel. As shown in FIG. 9, the method 160 generally comprises generating a service request (either at a client computer (such as a smartphone), a kiosk, an asset interface, or some other connection to the system) (block 162), receiving the service request at the central processor (block 164), utilizing software to automatically identify an appropriate service provider in the service provider database (block 166), and automatically transmitting a service request to the service provider, along with any additional asset information which may be needed by the service provider (block 168). Alternatively, a user can identify an appropriate service provider as part of the original request. In one embodiment, if no response is received within a predetermined period of time, the request is resent (block 170). It is understood that any known method of tracking and managing asset service and/or maintenance can be utilized in the systems described herein.

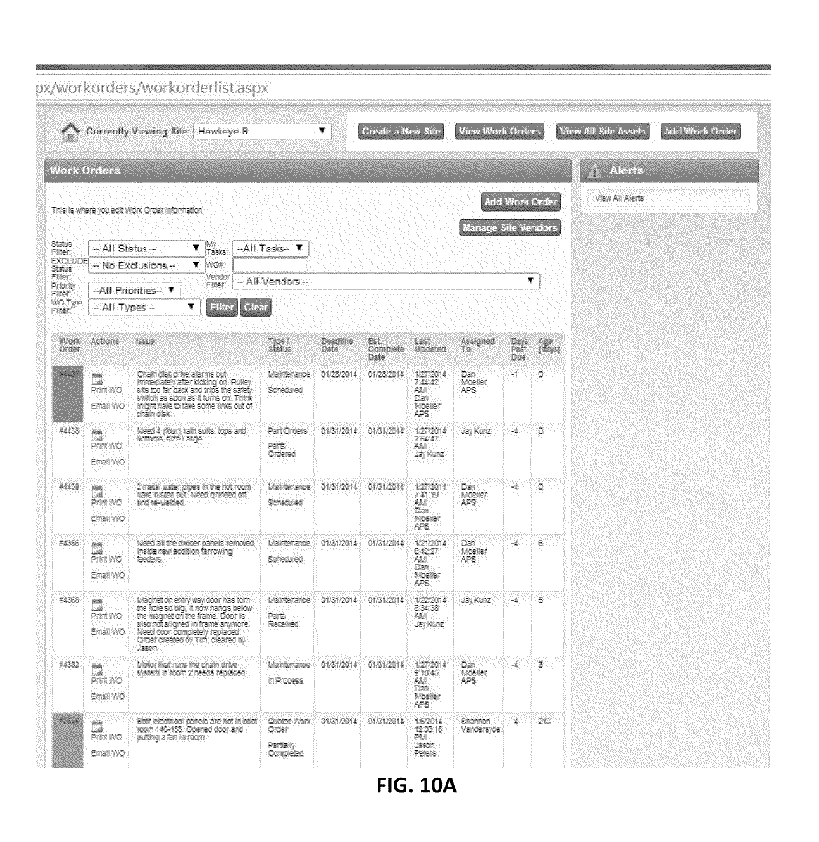

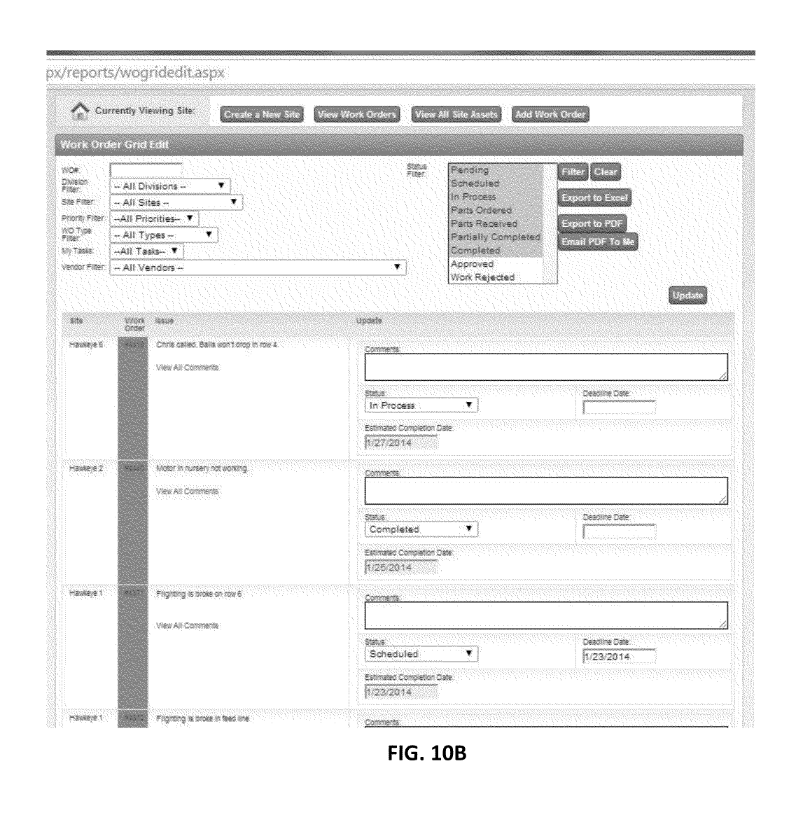

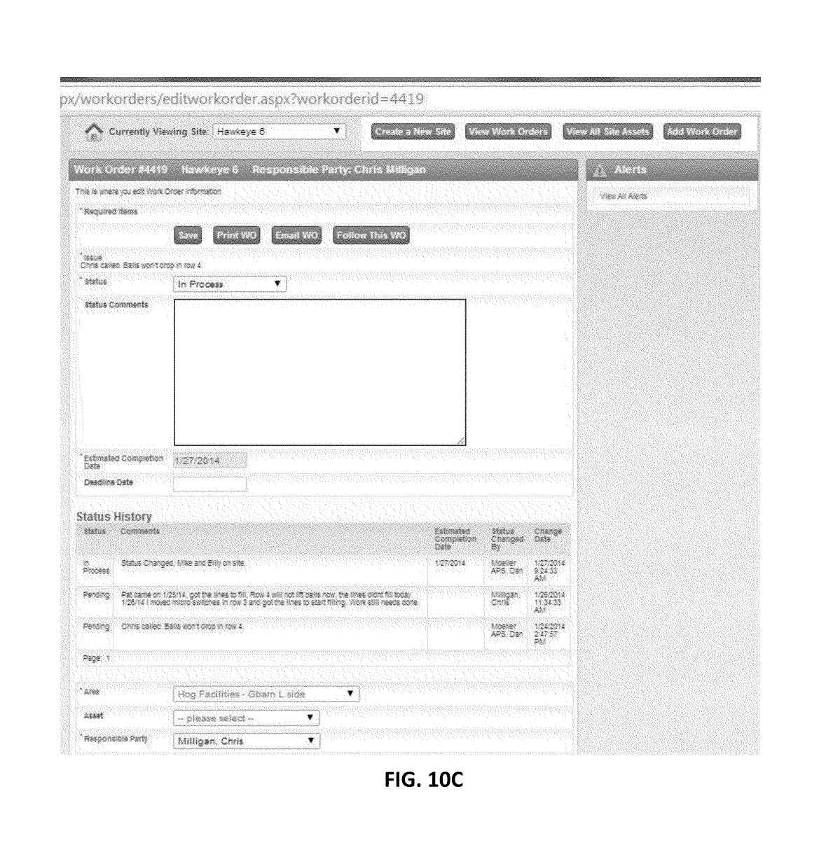

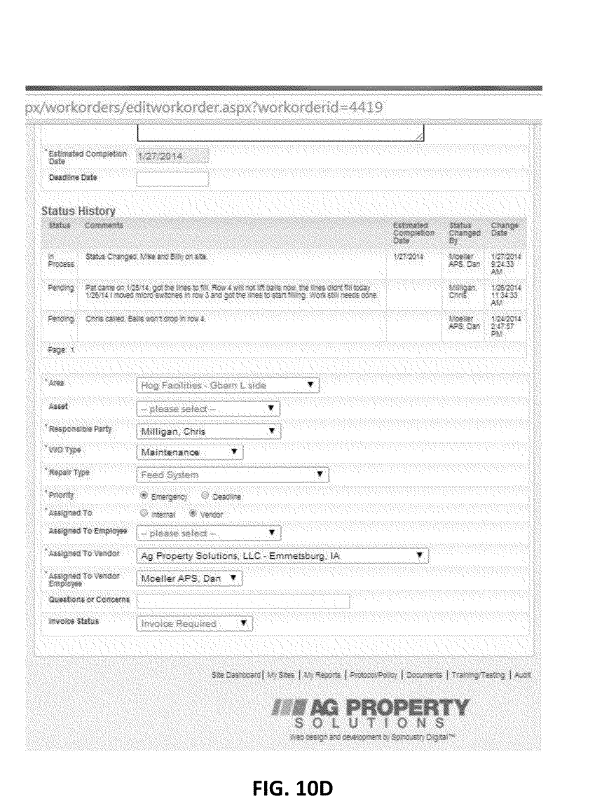

The generation and tracking of a service or maintenance request (also referred to herein as a “work order”) can include entering and tracking it on an interactive webpage or other similar interface that allows a user to access a specific service request based on a specific asset, a specific site, a type of service request, or any other known parameter. FIGS. 10A-10D depict various aspects of an exemplary webpage of an interface relating to the tracking or management of work orders. The webpage has several filters that allow a user to easily access specific work orders based on various parameters.

For example, FIG. 10A depicts an exemplary work order report webpage that has certain filters that can be used by a user to filter the work orders by certain attributes as set forth in the filters, including: work order status, task assignment, priority (i.e. emergency, past due, etc.), work order type (i.e. parts order, service order, etc.), vendor assignment, and work order number.

In addition, the user can view various types of information about a specific work order, including issue, work order type, work order status, estimated completion date, person assigned to, days past due, and age of work order. Further, the webpage can also allow the user to sort and prioritize work orders, edit work orders by clicking on the appropriate link, and print and/or e-mail a work order.

FIG. 10B is an example of a work order staging page that is also provided in certain system embodiments. The page allows a user to sort work orders based on various filters or view comments relating to any specific work order by causing the cursor to hover over the “View All Comments” language on each work order. Further, a user can edit comments, status, or a deadline date on this page with respect to any specific work order without having to first open that work order. In addition, a user can access a specific work order from this page by clicking on the work order, thereby opening the work order and making it possible to edit the work order from that page.

FIGS. 10C and 10D depict a webpage relating to a specific work order that has been opened by a user. Via this work order processing/edit page, a user can define the issue requiring work or resolution, change status, add comments, set a deadline date, set estimated completion date, view comment/status history, assign a work order to a specific area, location, and/or asset as necessary, choose a responsible party, set the work order priority (for example, the emergency priority alerts all superiors), set deadline, assign to a vendor or employee, and/or document any other important information.

In further implementations, the system can also provide for a user to capture invoice-level information in a work order, including, for example, items, parts, hours, etc., unit costs, extended prices, miscellaneous charges, sales tax, freight, invoice date, due date, discount date, and discount amount. Further, the system can provide a flag or other indicator that requires approval of the assigned responsible party. In addition, in certain embodiments, once the work order is approved, the system can export the information to be processed by an external/separate accounting system for financial reporting and cash disbursement.

The system can also provide several additional interactive webpages that allow a user to easily navigate through the interface and thus operate and/or use the system as described herein, including a general system dashboard (typically for access by administrators), a general site dashboard that can be used by any user assigned to a specific site to track various parameters relating to that site, a customizable specific site page that can be used and customized by any user assigned to a specific site to track various parameters relating to that site, a report page through which the system makes any number of customizable reports available, and a document page that can be used by any user assigned to a specific site to track specific documents (such as certifications, etc.) relating to that site.

Managing Standards and Audits

A “standard” is a predetermined (or predefined) operational or process requirement of an owner or its employees that can be evaluated as either “pass”/“fail” or “yes”/“no”. An audit can be a review of compliance with one or more standards.

The generation and tracking of one or more defined standards commences with the definition of one or more standards. In one embodiment, this definition step can include defining a category for indexing the standard. In one example, the categories are “universal,” “custom,” or “vendor.” These particular categories arise from the fact that standards can be established by any number of entities or individuals, including governmental entities, governing bodies, industry organizations, or individual companies or entities. Universal or industry standards are established by industry or regulatory sources for use by member or participating entities in operations and processes that can then be reviewed in audits. Other standards can be generated by vendors and made available for inclusion in audits. Alternatively, an individual entity (such as a private company or any type of entity) can generate custom or internal standards for tracking and inclusion in audits.

In addition, a risk index can also be add to the defined standards, in which the risk index is defined as “critical”, “major” or “minor.” The application of the risk index is applied at the discretion of the standard creator.

In accordance with certain embodiments, an audit template can be constructed for the system using all sources of standards (universal, vendor and custom). Alternatively, an audit template constructed by a vendor can be incorporated into the system. Further, a universal standard can be created by another entity (such as a governing body or the like) and incorporated into the system

Scoring Standards and Audits

According to one implementation, a scoring matrix is provided that includes an assignment of values to the risk index categories as well as an assignment of the required passing % and a defined fail %. If a standard is answered as “yes” or “pass” for compliance with such standard, the points are awarded by the system for accumulation in the total points for the audit. If a standard is answered “no” or “fail” for compliance, no points are awarded by the system.

Upon completion of the audit, the system calculates the total theoretical points for the audit by risk index and in the aggregate as well as total actual points accumulated by risk index and in aggregate. A compliance % is calculated for each risk index and in the aggregate and compared to the required passing and/or fail %.

The passing and fail thresholds are extrapolated by the system in one embodiment based on the quantity of standards for each risk index as multiplied by the passing and fail thresholds resulting in the total points required for a pass or fail result at each risk index and in the aggregate.

Standards that were not able to be evaluated are marked as such during completion of the audit and ignored for purposes of calculating the total points available, total points earned and resulting pass and/or fail %.

Reporting Standards and Audits

The system allows for reporting of both completed audit scores as well as an accumulation of user defined standards (i.e. subset of miscellaneous standards evaluated or subset of a specific audit). Additionally, the system provides for scoring such audit(s) and standard subsets in a manner as described above.

According to one implementation, audit and standard results can be reported by the system within specific date ranges, specific dates and trend ranges.

Deficiencies identified during the audit can result in an assigned workorder for corrective action that is linked by the system to a specific standard and also a specific audit. Such corrective action can then be reported and evaluated to see that an audit score that is below a passing threshold is corrected and adjusted to within a passing threshold as defined by the owner and/or vendor.

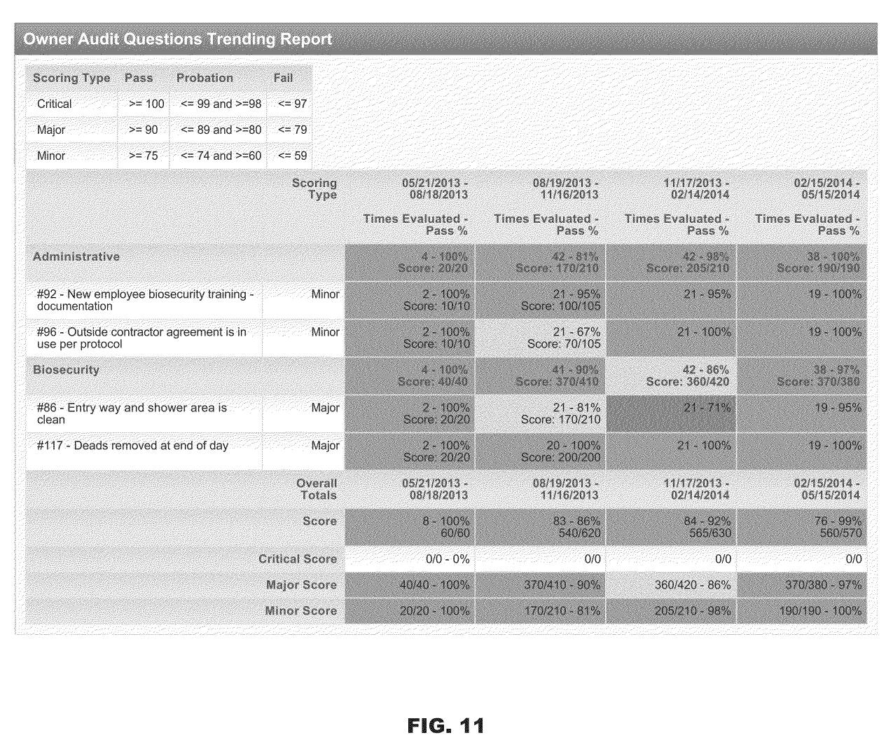

FIG. 11 depicts one example of certain aspects of the audit scoring and reporting. At this exemplary webpage, a user can set the filter for specific standards that the user wants to view, set trend attributes (for example—view the last four 90-day periods end as of a specific date), or review the scores, which are based on a system-assigned scoring system.

While multiple embodiments are disclosed herein, still other embodiments will become apparent to those skilled in the art from the following detailed description, which shows and describes illustrative embodiments of the various embodiments. As will be realized, the implementations are capable of modifications in various obvious aspects, all without departing from their spirit and scope. Accordingly, the drawings and detailed description are to be regarded as illustrative in nature and not restrictive.

What is claimed is:

1. A network-based system for tracking and managing various operational parameters of a production operation, the system comprising:
(a) a central processor accessible on a computer network;
(b) a database in communication with the central processor, the database configured to store:
(i) site and asset information relating to at least one site and at least one asset; and
(ii) compliance standard and audit information relating to the at least one site and the at least one asset; and
(c) standard compliance tracking software associated with the central processor, the standard compliance tracking software configured to track compliance with a standard associated with the at least one asset or site.

2. The system of claim 1, wherein the standard compliance tracking software is further configured to calculate compliance with the standard based on a score.

3. The system of claim 2, wherein the standard compliance tracking software is further configured to use a scoring matrix to calculate compliance with the standard.

4. The system of claim 1, wherein the standard compliance tracking software is further configured to generate a completed audit report.

5. The system of claim 1, wherein the standard compliance tracking software is further configured to generate a standard results report.

6. A network-based system for tracking and managing various operational parameters of a production operation, the system comprising:
(a) a central processor accessible on a computer network;
(b) a database in communication with the central processor, the database configured to store:
(i) site and asset information relating to at least one site and at least one asset;
(ii) policy and protocol information relating to the at least one site and the at least one asset; and
(ii) compliance standard and audit information relating to the at least one site and the at least one asset;
(c) policy and protocol tracking software associated with the central processor, the policy and protocol tracking software configured to track implementation of a policy or protocol associated with at least one asset or site; and
(d) standard compliance tracking software associated with the central processor, the standard compliance tracking software configured to track compliance with a standard associated with the at least one asset or site.

7. The system of claim 6, wherein the standard compliance tracking software is further configured to calculate compliance with the standard based on a score.

8. The system of claim 7, wherein the standard compliance tracking software is further configured to use a scoring matrix to calculate compliance with the standard.

9. The system of claim 6, wherein the standard compliance tracking software is further configured to generate a completed audit report.

10. The system of claim 6, wherein the standard compliance tracking software is further configured to generate a standard results report.

11. The system of claim 6, further comprising:
(a) the database being further configured to store:
(i) employee and user information; and
(ii) testing and training information relating to at least one employee; and
(b) employee proficiency tracking software associated with the central processor, the employee proficiency tracking software configured to track test results associated with the at least one employee.

12. The system of claim 6, further comprising:
(a) the database being further configured to store:
(i) compliance standard and audit information relating to the at least one site and the at least one asset; and
(b) compliance and audit tracking software associated with the central processor, the compliance and audit tracking software configured to track audit results associated with the at least one asset or site.

13. The system of claim 6, further comprising:
(a) the database being further configured to store:
(i) service provider information relating to the at least one site and the at least one asset; and
(b) service and maintenance tracking software associated with the central processor, the service and maintenance tracking software configured to identify an appropriate service provider based on a service request.

14. The system of claim 13, wherein the service and maintenance tracking software is further configured to transmit a service request to the appropriate service provider.

15. A network-based system for tracking and managing various operational parameters of a production operation, the system comprising:
(a) a central processor accessible on a computer network;
(b) a database in communication with the central processor, the database configured to store:
(i) site and asset information relating to at least one site and at least one asset;
(ii) employee and user information;
(iii) policy and protocol information relating to the at least one site and the at least one asset;
(iv) testing and training information relating to at least one employee;
(v) compliance standard and audit information relating to the at least one site and the at least one asset; and
(vi) service provider information relating to the at least one site and the at least one asset; and
(c) employee proficiency tracking software associated with the central processor, the employee proficiency tracking software configured to track test results associated with the at least one employee;
(d) policy and protocol tracking software associated with the central processor, the policy and protocol tracking software configured to track implementation of a policy or protocol associated with at least one asset or site;
(e) standard compliance tracking software associated with the central processor, the standard compliance tracking software configured to track compliance with a standard associated with the at least one asset or site; and
(f) service and maintenance tracking software associated with the central processor, the service and maintenance tracking software configured to identify an appropriate service provider based on a service request.

16. The system of claim 15, wherein the standard compliance tracking software is further configured to calculate compliance with the standard based on a score.

17. The system of claim 16, wherein the standard compliance tracking software is further configured to use a scoring matrix to calculate compliance with the standard.

18. The system of claim 15, wherein the standard compliance tracking software is further configured to generate a completed audit report.

19. The system of claim 15, wherein the standard compliance tracking software is further configured to generate a standard results report.

20. The system of claim 15, wherein the production operation is a livestock production operation.
